(19) United States
(12) Patent Application Publication
(10) Pub. No.: US 2004/0037753 A1
(43) Pub. Date: Feb. 26, 2004

(54) Filter matrix

(76) Inventors: Michael Quinn, Providenciales (TC); Donald Francis Donoahue, Oakville (CA)

Correspondence Address: MARKS & CLERK, 350 BURNHAMTHORPE ROAD WEST, SUITE 402, MISSISSAUGA, ON, L5B 3J1, CA

(21) Appl. No.: 10/226,336

(22) Filed: Aug. 23, 2002

(51) Int. Cl. B01D 50/00; B01D 53/34

(52) U.S. Cl. 422/177

(57) ABSTRACT

A filter matrix is provided which substantially overlies a broiler at a selective distance therefrom for reducing volatile particulate matter and organic compounds in broiler smoke. The filter matrix comprises at least one filter screen layer horizontally disposed above the broiler for arresting the broiler frame, and a stack of at least two expanded metal filter layers, the first of which is contiguous to the filter screen layer which is directly above the broiler. Each of the filter screen layers, and each of the expanded metal filter layers have a plurality of apertures defined therein arranged in an array, and the layers are stacked in such a manner that when the broiler smoke is passing through the filter matrix, the pathway of the broiler smoke is labyrinthine.

### FIELD OF THE INVENTION

This invention relates to filters, and particularly relates to a filter matrix substantially overlying a broiler at a selective distance therefrom, for reducing volatile broiling smoke particulate matter and organic compounds in broiling smoke.

### BACKGROUND OF THE INVENTION

The use of filters for reducing volatile broiling smoke particulate matter and organic compounds in broiling smoke emissions has, of course, been known for many years. Typically, the filters are placed at a selective distance from the source of the broiler smoke emissions and that the filters substantially overlie the broiler source.

In many instances, during food preparation, the burning of organic materials including fats, proteins, and/or carbohydrates generate large amounts of smoke. Particularly in restaurants, and especially fast food restaurants, where the preferred method of cooking is broiling by using such cooking devices as broilers and fryers, large amounts of carbon monoxide, organic vapors and aerosols from the emissions of broiling fatty food, such as fatty hamburgers or the like, may be generated which can cause environmental, health and fire hazard. In order to subside the amount of broiling smoke generated, it is common practice to blow large amounts of air into and through the kitchens such that the smoke can escape through exhaust hoods and chimneys to the outside environment. This method of diluting the broiling smoke is expensive as heating or cooling consumes large amount of electrical energy. In fact, blowing the smoke away from the source simply transfers the smoke from indoors to outdoors, it does not reduce the amount of particulate matter and organic compounds found in broiling smoke.

In order to improve the air we breathe, it is important to reduce the broiling smoke emissions from broilers.

### DESCRIPTION OF THE PRIOR ART

Several typical prior art filter matrices are now described. They include BAR-ILAN U.S. Pat. No. 5,431,887, published Jul. 11, 1995, which teaches a catalytic assembly which is disposed above the broiling area of a fat food broiler. The assembly is intended to enable the catalytic oxidation of volatile broiling smoke organic contaminants. The catalytic oxidation unit comprises a filter screen and a coating for the filter screen. In fact, one of the stated objectives of the inventor is to provide the adhering of a coating to a metallic or similar substrate that serves as a flame arrester and dispersing screen. This screen or filter, may be an open pore screen, an expanded metal sheet, or the like. The coating on the screen is capable of adsorbing and retaining small amounts of particulate found in the hot broiler emissions as they are directed upwards through the filter. It is apparent from the teachings of BAR-ILAN that the catalytic oxidation unit provided has a single filter screen.

In another U.S. Pat. No. 5,556,819 issued also to the above inventor on Sep. 17, 1996, a method of making a flame arresting and contaminant-absorbing filter apparatus is taught. This patent is a Divisional application of the previously described patent.

In yet another U.S. Pat. No. 5,693,298 issued to the above inventor BAR-ILAN on Dec. 2, 1997, a catalytic assembly positioned above the broiling area of a fat food broiler is taught. This patent is a Divisional application of the issued U.S. Pat. No. 5,556,819. The inventor teaches a method of catalytic abatement of emissions comprising the steps of arresting and dispersing the fatty food broiling flames using a low pressure drop and flame arresting porous filter, passing the emissions through the catalyst positioned over the broiler, adsorbing the salt and phosphorous emissions from the fatty food on the filter, and oxidizing the broiler emissions using a catalyst. The inventor also teaches a binder chosen from the group consisting of titania, zirconia, and ceria.

In U.S. Pat. No. 5,599,509 issued to TOYAO et al. on Feb. 4, 1997, the inventors teach a metal catalyst convertor comprising of a metal catalyst carrier which holds the catalyst in a honeycomb shaped filter. The honeycomb body is created by alternately winding a flat sheet and a corrugated sheet together. A slit matrix, having a plurality of slits formed on the flat sheet, the corrugated sheet, or both, is located along a specific section of the filter. The slit matrix extends longitudinally the entire length of the metal sheets and vertically through approximately half the sheet, thus forming a low heat capacity area. The slit matrix, when in its rolled honeycomb form is arranged on the upstream side of the exhaust.

In U.S. Pat. No. 5,622,100 issued to KING et al. on Apr. 22, 1997, the inventors teach a smoke abatement assembly which is designed to overlie a cooking device such as a broiler or fryer cooking system in a commercial restaurant or the like. The low pressure flame arrester is positioned above the cooking area and has the dual purpose of mixing the smoke and arresting the flames. The performance of the catalysts within the flame arrester are dependent on the space velocity which is defined as the volume of gaseous liquid flowing through the catalyst per hour divided by the catalyst volume. The critical range of flow velocity as determined by the inventors is between 30 feet and 80 feet per second. The solid inorganics present in the broiler emissions pass through the flame arrester. Furthermore, the inventors teach a short and large diameter catalyst region without the need for supplementary heating or fans. An objective of the teachings of the inventors is to substantially equalize the cooking area and the catalyst flow area so as to eliminate hot spots, and to achieve a slow and uniform smoke flow through the catalyst. A typical catalyst filter structure is a honeycomb structure with no less than 25 cells and no more than 300 cells per inch with honeycomb walls approximately 5 millimetres thick.

Finally, in U.S. Pat. No. 5,821,194 issued to IN on Oct. 13, 1998, the inventor teaches a catalyst for purifying the exhaust gas of vehicles, where the catalyst is formed from a series of layers. The catalyst is constructed from a metallic corrugated substrate formed in a scroll and engaged with a flat substrate, an intermediate layer of ceramic provided on both the flat and corrugated substrates, and a catalytic layer provided on the intermediate layer. This patent also teaches a plurality of holes formed in the corrugated substrate and flat substrates and filled with the intermediate layer of ceramic. The exhaust gas passes through the cells formed between the metallic substrates, and moves therethrough. The gas may diffuse into adjacent cells through the holes formed on the flat substrate and on the corrugated substrate. This increases the purification efficiency of the exhaust gas passing through the substrate.

### SUMMARY OF THE INVENTION

In accordance with one aspect of the present invention, there is provided a filter matrix substantially overlying a broiler at a selective distance therefrom for reducing volatile particulate matter and organic compounds in broiler smoke.

The filter matrix of the present invention comprises at least one filter screen layer horizontally disposed above the broiler for arresting the broiler frame, and a stack of at least two expanded metal filter layers, the first of which is contiguous to the filter screen layer which is directly above the broiler.

Each of the at least one filter screen layer is flat and has a plurality of pre-determined apertures defined therein arranged in an array for the passage of broiler smoke therethrough. Generally, each of the apertures is diamond-shaped.

Also, each of the expanded metal filter layers has a plurality of predetermined apertures defined therein arranged in an array for the passage of broiler smoke therethrough. Furthermore, each of the apertures in each of the expanded metal filter layers is diamond-shaped defined by four walls which are inclined at an angle.

Each of the expanded metal filter layers has a major axis and a minor axis such that when the expanded metal filter layers are stacked, the major axis of one of the expanded metal filter layers is perpendicular to the major axis of the next adjacent expanded metal filter layer.

When the broiler smoke is passing through the filter matrix, the pathway of the broiler smoke is labyrinthine.

Typically, the four walls defining each of the apertures in each of the expanded metal filter layers is inclined at an angle between 30 to 70 degrees.

The filter screen layer is manufactured from steel. The expanded metal filter layer is manufactured from materials chosen from the group of materials consisting of iron, chromium, aluminum, yttrium, zirconium, and combinations and mixtures thereof.

The filter screen layer has a catalytic coating thereon. Typically, the catalytic coating on the filter screen layer has a precious metal catalyst.

Moreover, the expanded metal filter layer has a catalytic coating thereon. Typically, the catalytic coating on the expanded metal filter layer has a precious metal catalyst.

Each of the filter screen layers has 68% of openings to 32% of materials per square. Furthermore, each of the expanded metal filter layers has 42% of openings to 58% of materials per square.

Typically, the filter matrix functions from a range of 300° F. to 1100° F. at a ventilation rate of 50 to 3600 feet per minute.

In keeping with one aspect of the present invention, a stack of at least two expanded metal filter layers is sandwiched between two filter screen layers.

In keeping with another aspect of the present invention, the filter matrix is mounted in a frame.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a side elevation view of a filter matrix substantially overlying a broiler at a selective distance therefrom;

FIG. 2 is a top view of a portion of filter screen layer;

FIG. 3 is a top view of an expanded metal filter layer; and

FIG. 4 is a side sectional view of a stack of expanded metal filter layers.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

As noted above, a feature of the present invention is to provide a filter matrix substantially overlying a broiler at a selective distance therefrom for reducing volatile particulate matter and organic compounds in broiler smoke. It has been found that at least 85% of hydrocarbons and particulate matter may be destroyed by using such a filter matrix. Typically, the filter matrix is located 4 to 10 inches from the broiler smoke emission source. Furthermore, the filter matrix generally functions from a range of 300° F. to 1100° F. at a ventilation rate of 50 to 3600 feet per minute.

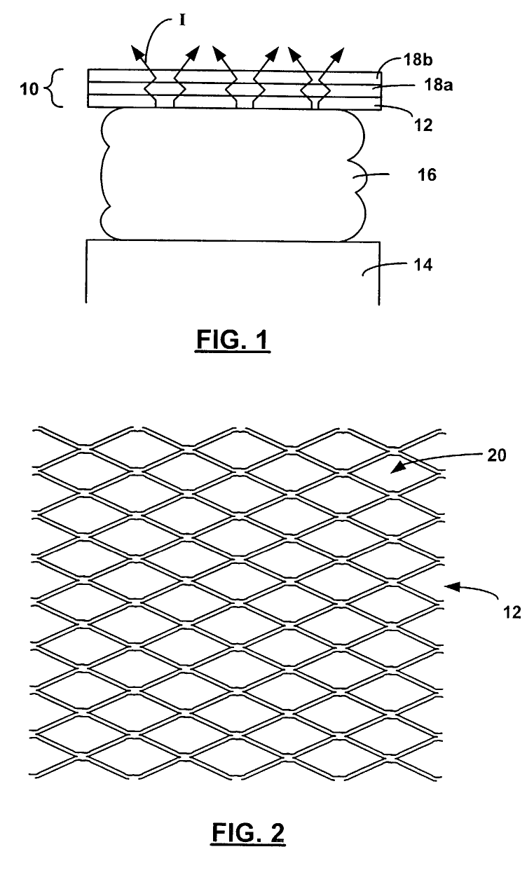

Turning first to FIG. 1, the filter matrix 10 comprises at least one filter screen 12 horizontally disposed above the broiler 14 for arresting the broiler frame 16, and a stack of at least two expanded metal filter layers 18a and 18b. As is shown in the figure, the first of the expanded metal filter layer 18a is contiguous to the filter screen layer 12 which is directly above the broiler 10. When the broiler smoke is passing through the filter matrix 10, the pathway of the broiler smoke is labyrinthine, as is shown by dashed arrow I.

In FIG. 2, a top view of a filter screen layer 12 is shown. The filter screen layer 12 is flat and has a plurality of pre-determined apertures 20 defined therein arranged in an array for the passage of broiler smoke therethrough. Each of the apertures 20 is diamond-shaped. In general, each of the filter screen layers has 68% of openings to 32% of materials per square.

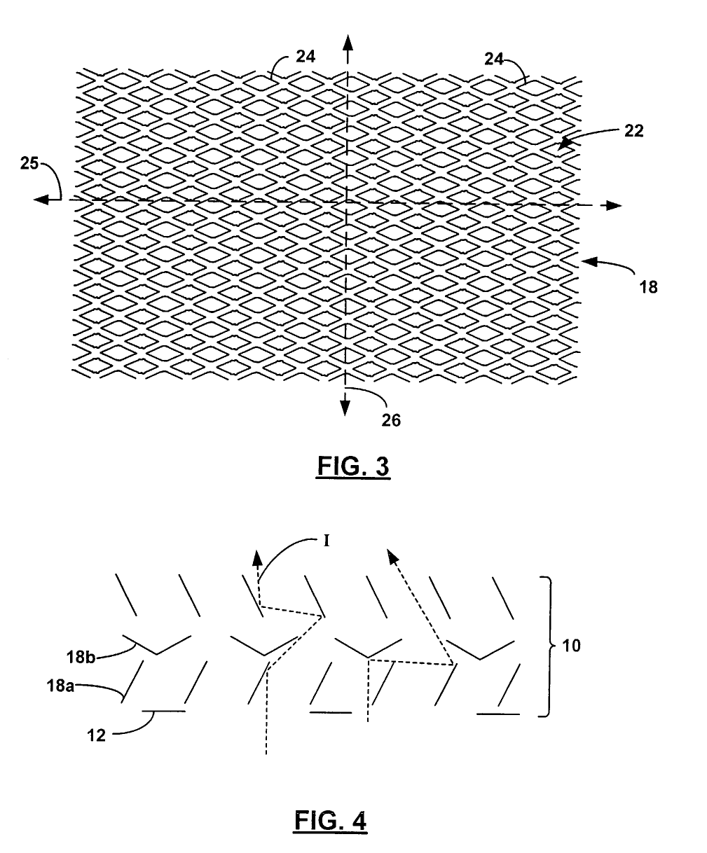

As shown in FIG. 3, the expanded metal layer 18 also has a plurality of pre-determined apertures 22 defined therein arranged in an array for the passage of broiler smoke therethrough. Each of the apertures 22 in the expanded metal filter layer 18 is diamond-shaped defined by four walls 24 which are inclined at an angle. Typically, the four walls 24 defining each of the apertures 22 in each of the expanded metal filter layers 18 is inclined at an angle between 30 to 70 degrees. In general, each of the expanded metal filter layers 18 has 42% of openings to 58% of materials per square.

Furthermore, each of the expanded metal filter layers 18 has a major axis 25 and a minor axis 26 such that when the expanded metal filter layers 18 are stacked, the major axis 25 of one of the expanded metal filter layers 18a is perpendicular to the major axis 25 of the next adjacent expanded metal filter layer 18b. Indeed, when the broiler smoke is passing through the filter matrix 10, the pathway of the broiler smoke is labyrinthine, as is shown by dashed arrow I (FIG. 4).

Typically, the filter screen layer 12 is manufactured from stainless steel.

The expanded metal filter layer 18 is manufactured from alloys of the metals chosen from the group of iron, chromium, aluminum, zirconium, and combinations and mixtures thereof.

In keeping with one aspect of the present invention, the filter screen layer 12 has a catalytic coating thereon. The catalytic coating has a precious metal catalyst. In keeping with another aspect of the present invention, the expanded metal filter layer 18 has a catalytic coating thereon, and the catalytic coating has a precious metal catalyst. The use of precious metal catalyst for the intended purposes herein is well known to those skilled in the art. It is important to note that it is possible for a filter matrix 10 with filter screen layer 12 and expanded metal filter layer 18 both having catalytic coating thereon.

In one embodiment of the present invention, a stack of at least two expanded metal filter layers 18 is sandwiched between two filter screen layers 12.

The filter matrix 10 may also mountable in a frame 30. Indeed, each of the layers of the filter matrix 10 may be removably secured inside the frame 30.

Typically, the filter matrix 10 consists of six to eight layers of expanded metal filter layers 18 sandwiched between two outer filter screen layers 12. Each of the apertures 22 in each of the expanded metal filter layers 18 is defined by the four walls 24 which are inclined at an angle of 60 degrees such that the broiler smoke passing through each of the apertures 22 comes in contact with the material surface. The apertures 22 of the expanded metal filter layer 18, and the apertures 20 of the filter screen layer 12 have been dimensioned such that back pressure of the broiler smoke is minimized. It has been found that for a filter matrix 10 having eight or more layers, significant reduction of volatile particulate matter and organic compounds in broiler smoke may also be achieved in the absence of a catalytic coating on the layers.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A filter matrix substantially overlying a broiler at a selective distance therefrom for reducing volatile particulate matter and organic compounds in broiler smoke, said filter matrix comprising:
at least one filter screen layer horizontally disposed above the broiler for arresting the broiler frame; and
a stack of at least two expanded metal filter layers, the first of which is contiguous to said filter screen layer which is directly above the broiler;
wherein each of said at least one filter screen layer is flat and has a plurality of pre-determined apertures defined therein arranged in an array for the passage of broiler smoke therethrough, and wherein each of said apertures is diamond-shaped;
wherein each of said expanded metal filter layers has a plurality of predetermined apertures defined therein arranged in an array for the passage of broiler smoke therethrough,
wherein each of said apertures in each of said expanded metal filter layers is diamond-shaped defined by four walls which are inclined at an angle; and
wherein each of said expanded metal filter layers has a major axis and a minor axis such that when said expanded metal filter layers are stacked, said major axis of one of said expanded metal filter layers is perpendicular to the major axis of the next adjacent expanded metal filter layer;
whereby when the broiler smoke is passing through said filter matrix, the pathway of the broiler smoke is labyrinthine.

2. The filter matrix according to claim 1, wherein said four walls defining each of said apertures in each of said expanded metal filter layers is inclined at an angle between 30 to 70 degrees.

3. The filter matrix according to claim 1, wherein said filter screen layer is manufactured from steel.

4. The filter matrix according to claim 1, wherein said expanded metal filter layer is manufactured from materials chosen from the group of materials consisting of iron, chromium, aluminum, yttrium, zirconium, and combinations and mixtures thereof.

5. The filter matrix according to claim 1, wherein said filter screen layer has a catalytic coating thereon.

6. The filter matrix according to claims 1, wherein said catalytic coating has a precious metal catalyst.

7. The filter matrix according to claim 1, wherein said expanded metal filter layer has a catalytic coating thereon.

8. The filter matrix according to claims 1, wherein said catalytic coating has a precious metal catalyst.

9. The filter matrix according to claim 1, wherein each of said filter screen layers has 68% of openings to 32% of materials per square.

10. The filter matrix according to claim 1, wherein each of said expanded metal filter layers has 42% openings to 58% of materials per square.

11. The filter matrix according to claim 1, wherein said filter matrix functions from a range of 300° F. to 1100° F. at a ventilation rate of 50 to 3600 feet per minute.

12. The filter matrix according to claim 1, wherein a stack of at least two expanded metal filter layers is sandwiched between two said filter screen layers.

13. The filter matrix according to claim 1, wherein said filter matrix is mounted in a frame.
